(19) United States
(12) Patent Application Publication
(10) Pub. No.: US 2005/0266194 A1
(43) Pub. Date: Dec. 1, 2005

(54) Peelable laminate and process of making the same

(76) Inventor: Daniel F. Peters, Hamilton, OH (US)

Correspondence Address: R. William Graham, 22 S. St. Clair St., Dayton, OH, 45402, US

(21) Appl. No.: 10/857,120

(22) Filed: May 29, 2004

(51) Int. Cl. B32B 9/00

(52) U.S. Cl. 428/40.1

(57) ABSTRACT

A peelable laminate includes a pulp paper-based substrate having a treated side to prevent undue adhesion to pulp fibers extending from the side and a polymer coating applied to the treated side in a manner such that the polymer coating is adhered to the treated side in a peelable manner.

### BACKGROUND OF THE INVENTION

1. Field of Invention

The present invention relates to laminates and methods of forming the same. More particularly, the invention relates to paper laminates and products therefrom and methods of forming the same.

2. Related Art

There exists a number of laminates in which one part of the laminate can be peeled apart for in intended purpose. For example, labels are commonly formed by laminating a paper substrate on a release backing via a pressure sensitive adhesive so that they may be printed upon and subsequently removed from the release liner for placement on the intended article. Once the label is typically affixed to the article, its utility is complete.

In the case of using these labels in certain fields, such as in the pharmacological field, the current art does not provide an acceptable product. This is because Health Insurance Portability and Accountability Act (HIPAA) requires that containers bearing such labels be destroyed for various reasons including confidentiality, prevention of unauthorized or prescribed use, for example. This is a nuisance to the industry as well as the user who may simply wish to retain the container for information purposes only.

Further, labels in the security field lack adequate security features to prevent theft of goods. For example, many goods use adhesive labels for pricing which can be transposed onto other goods to reflect inaccurate pricing.

As it relates to the instant invention, preformed business cards for use in laser printers or the like are commonly formed by providing either micro-perforations or substantial cut lines between the cards which after the printing operation thereon, are separated from one another by tearing along the remaining connecting parts of the cards. No matter the claims of the prior attempts, the cards provided after separation do not have a clean cut as would be the case if performed by a die cut in a printing process. The resultant edges give the card a less professional look than clean knife cut edges and in certain uses are unacceptable. There is a significant need in the laser and ink jet card products industry to provide clean edges similar to the main stream business cards.

The present invention overcomes the deficiencies in the art of labels and preformed cards.

### SUMMARY OF THE INVENTION

It is an object to provide an improved peelable laminate.

It is another object to improve the method of making a peelable laminate.

It is yet another object to improve labels.

It is a further object to improve preformed business cards for use in printers.

It is still another object to improve the use of labels in the pharmacological field.

It is another object to improve the use of labels the security field.

It is yet another object to improve the use of labels in the coupon field.

Accordingly, one embodiment of the invention is directed to a peelable laminate. In one instance, the laminate includes a first pulp paper-based substrate having a treated surface to prevent undue adhesion to pulp fibers extending from said side, a polymer coating applied to said treated side, an adhesive (e.g., pressure sensitive adhesive) applied on said polymer coating and a release liner substrate applied to said adhesive. In one case, the treated surface is wet rolled to cause the fibers to lie down thus generally precluding an interlocking of the polymer capable of being coated onto the pulp paper-based substrate material to the pulp paper-based substrate in a permanent manner. In another case, the treatment can include clay coating the surface to provide release of the polymer capable of being coated onto the pulp paper-based substrate. The polymer capable of being coated onto the pulp paper-based substrate can be extruded onto the pulp paper-based substrate after the one side is treated as stated above. The polymer capable of being coated onto the pulp paper-based substrate can include an effective amount of cofax, i.e., a release agent, to prevent excessive bonding of the polymer capable of being coated onto the pulp paper-based substrate to the pulp paper-based substrate. The uses of such laminate, when die cut for example, provide for a unique label with a myriad of applications.

In another embodiment, the adhesive can be omitted from the above forming process and then the paper pulp paper-based substrate can be subsequently die cut in a manner to form cards, wherein the die cut is 100% through the paper pulp paper-based substrate with the polymer capable of being coated onto the pulp paper-based substrate layer serving to maintain the now formed cards in their orientation until forcibly removed from the polymer capable of being coated onto the pulp paper-based substrate layer. Until so removed, the cards can be printed upon using conventional printers, e.g. laser printers and the like. Thus, a superior and perfectly clean cut card edge can be provided not heretofore provided.

Other objects and advantages of the present invention will become more apparent to those persons having ordinary skill in the art to which the present invention pertains from the foregoing description taken in conjunction with the accompanying drawings.

### BRIEF DESCRIPTION OF THE DRAWINGS

FIG. 1 is a perspective view of one embodiment of the invention.

FIG. 2 is another perspective view of the invention.

FIG. 3 is a schematic illustrating the formation of one embodiment of the invention.

FIG. 4 is another schematic illustrating the formation of another embodiment of the invention.

FIG. 5 illustrates one use of the invention.

FIG. 6 illustrates another use of the invention.

FIG. 7 illustrates yet another use of the invention.

FIG. 8 illustrates still another use of the invention.

### DETAILED DESCRIPTION OF PREFERRED EMBODIMENTS OF THE INVENTION

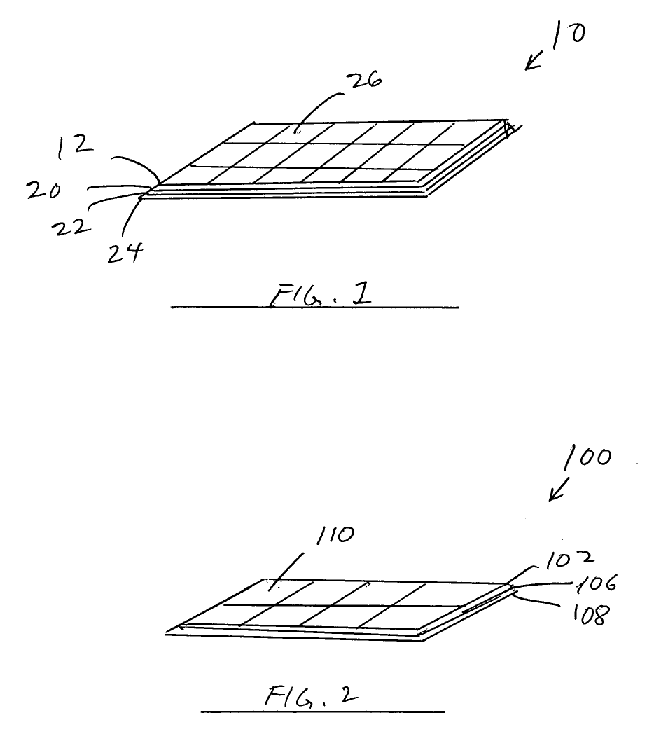

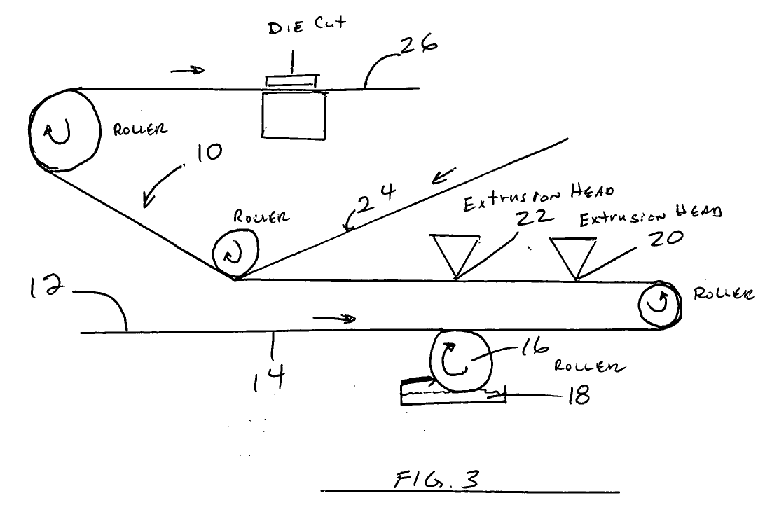

Referring to now to the drawings, a peelable laminate of the present invention is shown generally by the numeral 10 and 100. The peelable laminate 10, 100 is shown at the in FIGS. 1 and 2 before entering a convention printer and as it would be purchased by the user (after removal from its packaging (not shown)). The peelable laminate 10 includes a first pulp paper-based substrate 12 which can include a sheet of paper of 1 mil to 10 mil thicknesses, for example. In the forming process the sheet can be of a web roll type. The thickness of the sheet of paper is preferably between 1 and 3 mils for a label and 7-10 for business cards, for example. At least one side 14 of the substrate 12 is wet rolled by passing the substrate over an anilox roller 16 partially submersed in a water container 18 thereby treating the surface thereof in a manner cause the pulp fibers extending from side 14 to lie down to prevent undue adhesion to the same.

A polymer coating 20 applied to the treated side 14 which can be by extruding in a curtain form over the side 14. The polymer coating 20 need be of a characteristic to permit the same to be coated onto substrate 12, for example, polyethylene, polyester, polypropylene are thought to be suitable and preferably can be polyethylene. The polymer coating 20 can include an effective amount of release or flow control agent, e.g., Profax™ commercially available from Montell or M. Holland Company, to prevent excessive bonding of the polymer capable of being coated onto the pulp paper-based substrate to the pulp paper-based substrate. The polymer coating 20 can be made either slightly opaque with opacifiers or made generally translucent. In one case, the treated side 14 is wet rolled to cause the fibers to lie down thus generally precluding an interlocking of the polymer coating 20 to the pulp paper-based substrate 12 in a permanent manner. In another case, the treatment can include clay coating the surface to provide release of the polymer coating 20. In either case, the pulp fiber is treated to prevent undue migration of the polymer capable of being coated onto the pulp paper-based substrate into the substrate 12.

An adhesive 22 (e.g., pressure sensitive adhesive) can be applied on the over polymer coating 20 and a release liner substrate 24 applied to the adhesive coating 22. The uses of such laminate 10, when die cut in one manner, for example, provide for a unique label 26 with a myriad of applications. A pattern of label portions 26 can be defined on the sheet by a die cut lines entirely through the pulp paper-based substrate 12. The label portions 26 can be rectangular, but other shapes are within the scope of the invention. In the forming process the laminate 10 can be cut to have dimensions of 8 1/2×11 inches whereas the pulp paper-based substrate 12, polymer coating 20, and adhesive 22 can be cut to have the dimensions of a traditional label portion 26 (e.g., 2×4 inches) with the release liner substrate 24 of the laminate having the dimensions of 8½×11 inches.

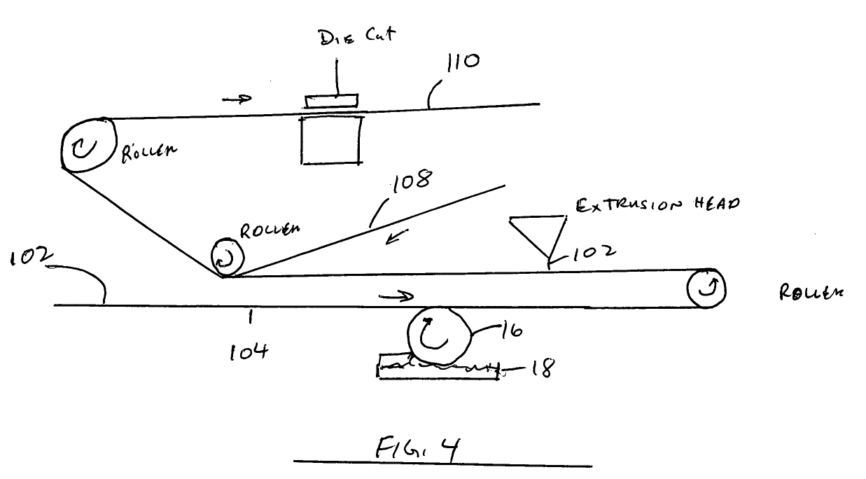

As an example, FIG. 5 illustrates one use of the invention wherein the label portion 26 is used on a pharmacological bottle 28. As illustrated here, the adhesive 22 is used to retain the polymer coating 20 onto the bottle 28 while the pulp paper-based substrate 12 can be peeled off after use to enable disposal of the bottle 28 in any conventional manner and the pulp paper-based substrate 12 bearing printed indicia 30 can be retained by the user or easily destroyed.

FIG. 6 illustrates another use of the invention. Here, the label portion 26 is used on product 32 bearing bar code indicia 34. Similarly, removal of the pulp paper-based substrate 12 does not enable reaffixing to another product as the polymer coating 20 and adhesive 22 remain attached to the product 32.

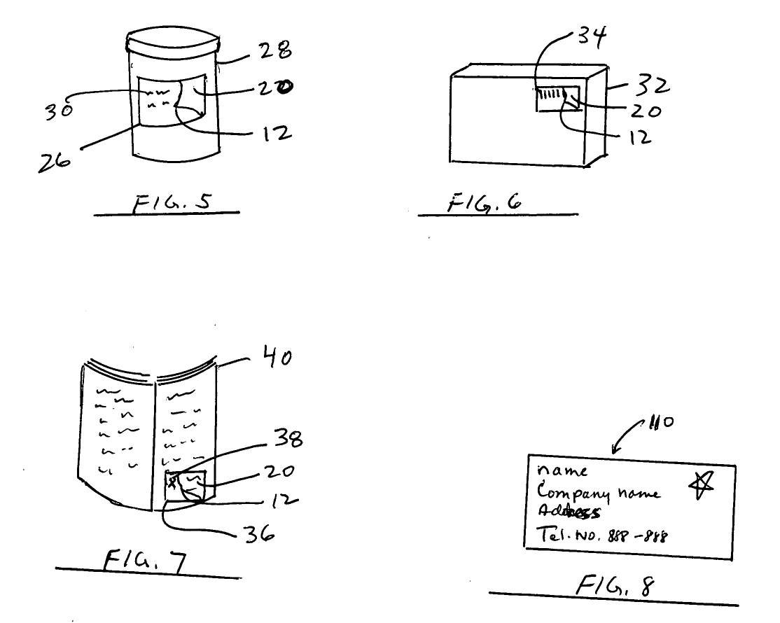

FIG. 7 illustrates yet another use of the invention. The label portion 26 can be used as a coupon 36 bearing saving indicia 38. Here, coupon 36 can be applied to a newspaper 40 and easily removed leaving the newspaper 40 readable as the polymer coating 20 and adhesive 22 remain in a transparent manner to permit reading of the newspaper 40.

FIG. 8 illustrates still another use of the invention. The adhesive can be omitted from the above forming process which can provide for another type of peelable laminate 100. Here, the laminate 100 includes paper pulp paper-based substrate 102 includes a treated side 104 in a manner similarly described above. Applied to the paper pulp paper-based substrate 102 is polymer coating 106 as described above. A pulp paper based backing substrate 108 can be applied to the polymer coating 106. The paper pulp paper-based substrate 102 can be subsequently die cut in a manner to form card portions 110, wherein the die cut is 100% through the paper pulp paper-based substrate 102 with the polymer capable of being coated onto the pulp paper-based substrate layer 106 and backing 108 serving to maintain the now formed card portions 110 in their orientation until forcibly removed from the polymer capable of being coated onto the pulp paper-based substrate layer 106. The card portions 110 can be rectangular, but other shapes are within the scope of the invention. In the forming process the laminate 100 can be cut to have dimensions of 8 1/2×11 inches whereas the pulp paper-based substrate 102 can be cut to have the dimensions of a traditional business card portions 110 (e.g., 2×3½inches) with the polymer capable of being coated onto the pulp paper-based substrate layer 106 and backing 108 of the laminate 100 having the dimensions of 8 1/2×11 inches. Thus, a superior and perfectly clean cut card edge can be provided not heretofore provided. Until so removed, the card portions 110 remain oriented to make up the 8 1/2×11 sheet which can be printed upon using conventional printers, e.g. laser printer, ink jet printer, photocopier and the like. As an example, indicia 112 can be printed on the business cards and include the individual's name, address, company name, telephone and facsimile numbers and/or E-mail addresses, etc.

The above described embodiments are set forth by way of example and are not for the purpose of limiting the present invention. It will be readily apparent to those skilled in the art that obvious modifications, derivations and variations can be made to the embodiments without departing from the scope of the invention. Accordingly, the claims appended hereto should be read in their full scope including any such modifications, derivations and variations.

1. A peelable laminate, which includes:
a pulp paper-based substrate having a treated side to prevent undue adhesion to pulp fibers extending from said side; and
a polymer coating applied to said treated side in a manner such that said polymer coating is adhered to said treated side in a peelable manner;
an adhesive applied on said polymer coating; and
a release liner substrate applied to said adhesive.

2. The peeleable laminate of claim 1, wherein said treated surface is characterized to be wet rolled to cause pulp fibers to lie down generally precluding an interlocking of said polymer coating to said pulp paper-based substrate in a permanent manner.

3. The peeleable laminate of claim 1, wherein said treated surface is characterized to be clay coated to provide release of said polymer coating.

4. The peeleable laminate of claim 1, wherein said polymer coating is an extruded coating generally covering said treated side.

5. The peeleable laminate of claim 1, wherein said polymer coating includes an effective amount of release agent to further aid in preventing excessive bonding to said pulp paper-based substrate.

6. The peeleable laminate of claim 1, wherein said laminate is die cut in a sheet.

7. The peeleable laminate of claim 1, wherein said laminate is die cut in a manner to cut 100% through said pulp paper-based substrate without cutting said release liner substrate.

8. The peeleable laminate of claim 1, wherein said laminate is cut 100% through said pulp paper-based substrate, said polymer coating and said adhesive without cutting said release liner substrate.

9. The peeleable laminate of claim 8, wherein said laminate includes a die cut label portion.

10. A peelable laminate, which includes:
a pulp paper-based substrate having a treated side to prevent undue adhesion to pulp fibers extending from said side; and
a polymer coating applied to said treated side in a manner such that said polymer coating is adhered to said treated side in a peelable manner.

11. The peeleable laminate of claim 10, which includes a release liner substrate applied to said polymer coating.

12. The peeleable laminate of claim 10, wherein said treated surface is characterized to be wet rolled to cause pulp fibers to lie down generally precluding an interlocking of said polymer coating to said pulp paper-based substrate in a permanent manner.

13. The peeleable laminate of claim 10, wherein said treated surface is characterized to be clay coated to provide release of said polymer coating.

14. The peeleable laminate of claim 10, wherein said polymer coating is an extruded coating generally covering said treated side.

15. The peeleable laminate of claim 10, wherein said polymer coating includes an effective amount of release agent to further aid in preventing excessive bonding to said pulp paper-based substrate.

16. The peeleable laminate of claim 10, wherein said laminate is die cut in a sheet.

17. The peeleable laminate of claim 10, wherein said laminate is die cut in a manner to cut 100% through said pulp paper-based substrate without cutting said polymer coating.

18. The peeleable laminate of claim 17, wherein said pulp paper-based substrate is of a card stock mil and said laminate includes a die cut card portion.

19. The peeleable laminate of claim 11, which includes an adhesive applied between said release liner and said polymer coating.

20. The peeleable laminate of claim 19, wherein said laminate is cut 100% through said pulp paper-based substrate, said polymer coating and said adhesive without cutting said release liner substrate.

21. The peeleable laminate of claim 10, wherein said laminate is die cut in a sheet.

22. The peeleable laminate of claim 20, wherein said laminate includes a die cut label portion.

23. A method of forming a peelable laminate, which includes:
(a) treating a side of a pulp paper-based substrate to prevent undue adhesion to pulp fibers extending from said side; and
(b) applying a polymer coating to said treated side in a manner such that said polymer coating is adhered to said treated side in a peelable manner.

24. The method of claim 23, which includes the step of applying a release liner substrate to said polymer coating.

25. The method of claim 23, wherein said treating is characterized to be wet rolling said side to cause pulp fibers to lie down generally precluding an interlocking of said polymer coating to said pulp paper-based substrate in a permanent manner.

26. The method of claim 23, wherein said treating is characterized to be clay coating to provide release of said polymer coating.

27. The method of claim 23, wherein said applying is characterized to be extruding.

28. The method of claim 23, which includes adding an effective amount of release agent to said polymer coating to aid in preventing excessive bonding to said pulp paper-based substrate.

29. The method of claim 23, which includes the step of die cutting said laminate in a manner to cut 100% through said pulp paper-based substrate without cutting said polymer coating wherein said laminate includes a die cut card portion.

30. The method of claim 24, which includes applying an adhesive applied between said release liner and said polymer coating and includes the step of die cutting said laminate in a manner to cut 100% through said pulp paper-based substrate, said polymer coating and said adhesive without cutting said release liner substrate wherein said laminate includes a die cut label portion.
